(19) United States
(12) Patent Application Publication
(10) Pub. No.: US 2014/0308892 A1
(43) Pub. Date: Oct. 16, 2014

(54) SMART UPCONVERTER FOR BROADBAND SATELLITE COMMUNICATION

(71) Applicant: XMW INC., Daejeon (KR)

(72) Inventor: Moohong Lee, Daejeon (KR)

(21) Appl. No.: 14/358,091

(22) PCT Filed: Oct. 4, 2012
(86) PCT No.: PCT/KR2012/008012

§ 371 Date: May 14, 2014

(30) Foreign Application Priority Data
Sep. 25, 2012 (KR) 10-2012-0106256

(51) Int. Cl. H04B 7/185; H04B 17/02; H04B 15/00

(52) U.S. Cl. CPC H04B 7/1858; H04B 15/00; H04B 17/024
USPC 455/9; 455/12.1

(57) ABSTRACT

The present invention relates to a smart upconverter for a broadband satellite communication. The smart upconverter of the present invention automatically senses the detailed band from among the IF bands of a broadband in a broadband satellite communication earth station, to which a transmission signal belongs, and pre-removes the detailed band which is not used in upconverting but generates spurious, thus preventing spurious (2IF+LO) problems in an in-band including the transmission signal.

### TECHNICAL FIELD

The present invention relates generally to a smart upconverter for broadband satellite communication, and more particularly, to a smart upconverter for broadband satellite communication which is used for a satellite communication earth station transmitting broadband signals in the Ka band.

### BACKGROUND ART

FIG. 1 is a block diagram for describing a conventional satellite communication earth station. Referring to FIG. 1, to transmit a desired Internet signal from a satellite communication earth station to a satellite, as shown in FIG. 1, first, Internet data transmitted from a terrestrial network is converted into data for transmission to the satellite by a data converter 101. Then, the data for transmission to the satellite is modulated at baseband by a modulator-demodulator (modem) 102, converted into intermediate frequency (IF) band signals, and then transmitted to an upconverter 103.

The upconverter 103 converts the signals of the IF band into radio frequency (RF) band signals to be transmitted to the satellite through a process of amplification, filtering, upconverting, and further amplification. Subsequently, the RF band signals are amplified to have enough power to enable transmission to the satellite by a high power amplifier 104, and then are finally transmitted to the satellite through an antenna 105.

In general, C band (a band of 3 to 7 GHz), X band (a band of 7 to 9 GHz), Ku band (a band of 12 to 15 GHz), and Ka band (a band of 20 to 30 GHz) are mainly used as the RF band for satellite communication. According to a scheme or type of satellite service, IF bands such as a band of 950 to 1450 MHz and a band of 950 to 1700 MHz have been used. In recent years, an IF band of 950 to 1950 MHz has been widely used.

When the upconverter 103 converts the signals of the RF band to the signals of the IF band, the method of designing and implementing the upconverter 103 differs according to the RF band frequency to be converted and the width of the IF band.

When a frequency increases to a Ka band of 20 GHz or more, the signal to be processed generally has a short wavelength of about 1.5 cm. As such, there are relatively many undesired parasitic components. To decrease such undesired parasitic components, components are made smaller, and are sold in a bare chip type rather than a package type. Thus, a circuit is configured using a bare chip and a thin film substrate. In particular, when IFs are converted into RFs of the Ka band, a high-performance filter is required to remove spurious components generated in the upconverting process. However, it is very difficult to implement such a high-performance filter.

FIG. 2 is a view for describing a structure of a transmitter of the conventional satellite communication earth station. As shown in FIG. 2, in the upconverter for the conventional satellite communication earth station, signals of IF band transmitted from a modem are amplified by an amplifier 201, and undesired spurious components introduced from the modem and a transmission line are removed from the amplified signals using an IF filter 202. Then, the amplified signals are converted into signals of the RF band through a mixer 203 and a local oscillator 204.

In the RF band signals made in this way, unnecessary spurious components generated in the upconverting process of the mixer 203 are removed while passing through an RF filter 205. Then, the RF band signals are input into a gain amplifier 206 and an output amplifier 207, and their output is amplified. Then, the amplified output is input to the next stage.

The upconverter for the conventional satellite communication earth station mostly converts the frequencies of the IF band of 950 to 1450 MHz or the IF band of 950 to 1700 MHz into the frequencies of the C band, the X band, the Ku band, or the Ka band, all of which belong to the RF band for satellite communication. However, many unnecessary spurious components are inevitably generated in the upconverting process that is performed by the mixer 203 of the upconverter. When not appropriately removed, these spurious components influence other channels within the RF band for transmitting the satellite signals. This leads to degradation in satellite communication quality.

To solve such problems, the spurious components are necessarily filtered by the RF filter 205 located after the mixer 203. Performance of the RF filter is dependent on the width of the IF band and the magnitude of the RF band frequency to be transmitted.

The wider the IF band or the higher the RF band frequency, the higher the degree of difficulty of filtering performed by the filter. This requires the use a high-performance filter. Current RF band pass filters for satellite communication include microstrip line filters, ceramic filters that are implemented on an alumina substrate using a thin film technique, and waveguide filters. In view of the degree of difficulty of design and manufacturing cost, microstrip line filters are least expensive, and waveguide filters are most expensive.

In recent years, in very high-speed Internet services using a satellite, satellite communication earth stations have begun to use an IF broadband of 950 to 1950 MHz, and RFs of a Ka band of 20 to 30 GHz. However, there is a problem in that a specific frequency component (2IF+LO) is generated from an in-band including transmission signals in a process in which the upconverter of the satellite communication earth station converts the IF band having a band width of 1 GHz into the desired RF band. For example, since a 2IF component of the IF signal of 950 MHz is 1900 MHz, the 2IF component belongs to the in-band. As such, it is difficult for the RF filter 205 located after the mixer 203 to remove the 2IF component. Also, these spurious components influence other channels in the in-band. To solve this problem, a mixer having a special structure capable of suppressing the problematic specific frequency component to a desired level or less may be used. However, this requires much time and cost.

### DOCUMENTS OF RELATED ART

1. Transmission Power Automatic Control Apparatus for Frequency Upconverter (Korean Patent Application No. 10-2001-0084288)

2. Frequency Upconverter (Korean Unexamined Patent Application Publication No. 10-2000-0059483)

### DISCLOSURE

### Technical Problem

The present invention has been made to solve the above-described problems, and an object of the present invention is to provide a smart upconverter for broadband satellite communication, in which a problem with specific spurious components generated during conversion of broadband IFs of 1 GHz for the purpose of application to a satellite earth station is solved to remove the influence of the spurious components on other channels, thereby greatly contributing to improvement in signal quality of satellite communication.

However, objects of the present invention are not limited to the above-mentioned object, and other objects that are not mentioned will be clearly understood by those skilled in the art based on the following description.

### Technical Solution

To accomplish the above-described object, a smart upconverter for broadband satellite communication according to an embodiment of the present invention automatically senses to which of detailed bands of an intermediate frequency (IF) broadband transmission signals belong at a broadband satellite communication earth station, pre-removes at least one of the detailed bands which generates spurious components (2IF+LO) that is not used in upconverting, and prevents a problem with the spurious components in an in-band including the transmission signals.

Here, the smart converter may further include a filter bank made up of detailed band pass filters, and a switch, both of which are provided to find the transmission channels in the IF broadband before first upconverting. After the first upconverting is performed, unnecessary spurious components may be removed by the filter, and levels of the signals may be measured by a signal level measurer, and be input to a controller.

Further, when the detailed band to which the transmission signals belong is converted into IFs by a mixer provided after the switch and by a local oscillator provided between the controller and the mixer, the filter may pass only one of the detailed band constituting the IF broadband so as to pass through one detailed band including the transmission channels and remove the remaining detailed band.

Further, the smart converter may further include an amplifier provided at a first stage to amplify overall signals of the IF broadband, and a distributor provided after the amplifier and distributing the detailed bands obtained by dividing the amplified signals of the IF broadband to the detailed band pass filters constituting the filter bank.

Further, the signals passing through each of the detailed band pass filters constituting the filter bank may pass through the switch, and may be input to the mixer. The switch may cause only one desired detailed band to be input by switching.

In addition, after the levels of the signals of the detailed band including the transmission channels among the detailed band of the IF broadband are stored, the levels of the signals passing through all the detailed band pass filters constituting the filter bank are measured by the signal level measurer in a process of switching the detailed band pass filters constituting the filter bank, the measured values are compared with each other, and a band having the highest signal level is determined as the detailed band.

### DESCRIPTION OF DRAWINGS

FIG. 1 is a block diagram for describing a conventional satellite communication earth station.

FIG. 2 is a view for describing a structure of a transmitter of the conventional satellite communication earth station.

FIG. 3 is a view for describing detailed bands and channels constituting an IF broadband in a smart upconverter for broadband satellite communication according to an embodiment of the present invention.

FIG. 4 is a view showing the smart upconverter for broadband satellite communication according to the embodiment of the present invention.

FIG. 5 is a flowchart showing a process of determining the detailed band in the smart upconverter for broadband satellite communication according to the embodiment of the present invention.

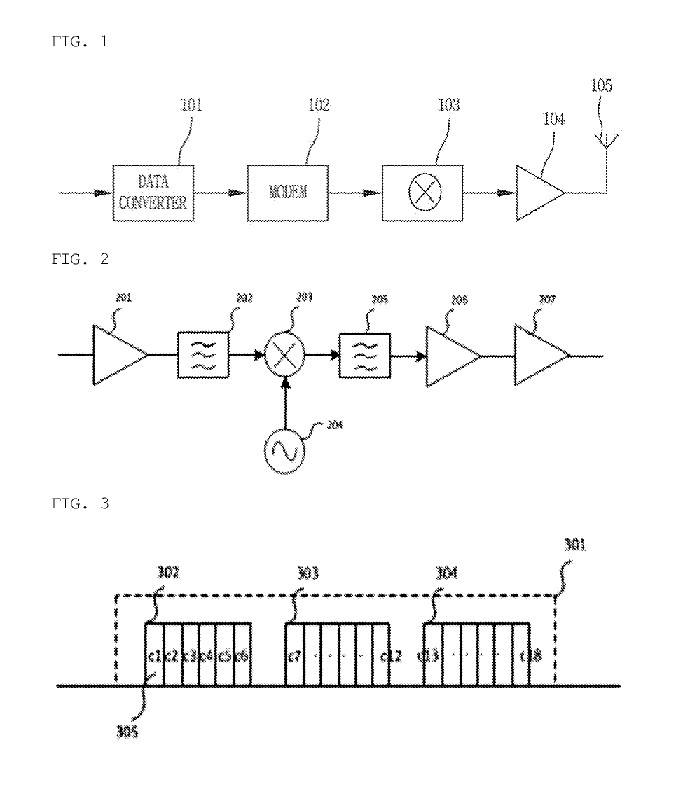

### REFERENCE SIGNS LIST

101: data converter

102: modulator and demodulator (MODEM)

103: upconverter

104: high power amplifier

105: antenna

201: amplifier

203: mixer

204: local oscillator

301: intermediate frequency (IF) band

302, 303, 304: detailed band

305: channel

401: amplifier

402: distributor

403, 404, 405: detailed band pass filter

406: filter bank

407: switch

408: first mixer

409: local oscillator

410: filter

411: signal level measurer

412: amplifier

413: filter

414: second mixer

415: local oscillator

416: filter

417: drive amplifier

418: output amplifier

419: controller

### MODE FOR INVENTION

Hereinafter, preferred embodiments according to the present invention will be described in detail with reference to the accompanying drawings. In the following description, when detailed description of known technology related to the present invention is considered to unnecessarily obscure the subject matter of the present invention, the detailed description will be omitted.

In the specification, when any component “transmits” data or signals to another component, it means that the component can directly transmit the data or the signals to the other component, and can transmit the data or the signals to the other component via at least one other component.

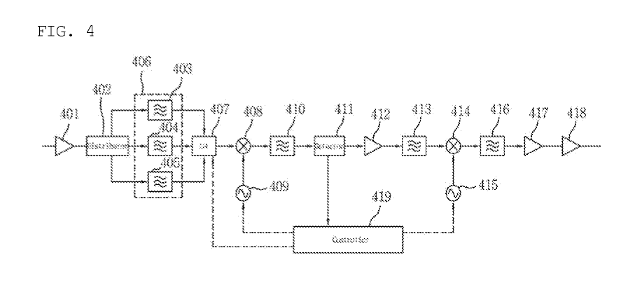

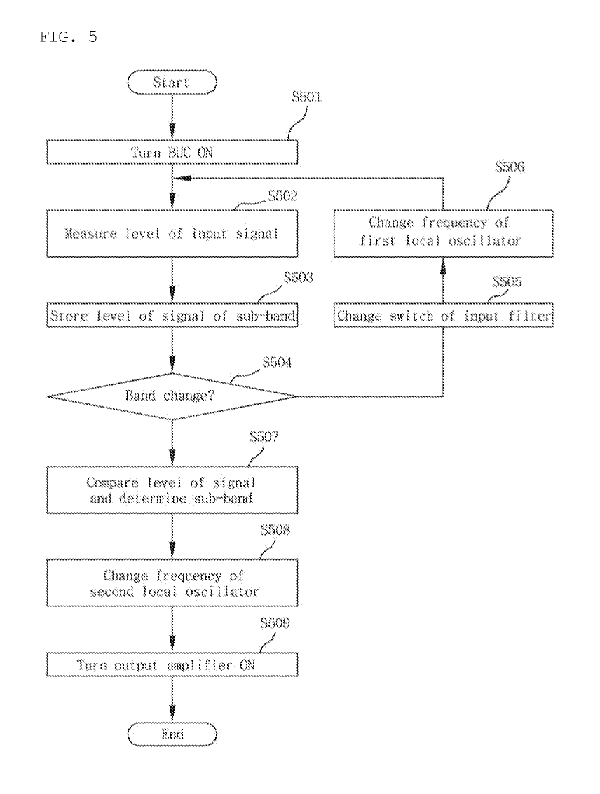

FIG. 3 is a view for describing detailed band and channels constituting an intermediate frequency (IF) broadband in a smart upconverter for broadband satellite communication according to an embodiment of the present invention. FIG. 4 is a view showing the smart upconverter for broadband satellite communication according to the embodiment of the present invention. Referring to FIGS. 3 and 4, the smart upconverter for broadband satellite communication is based on a double upconverting structure using two mixers 408 and 414 to determine to which of detailed band 302, 303, and 304 of an input IF band 301 of the smart upconverter for broadband satellite communication transmission signals of a satellite communication earth station belong.

Hereinafter, for convenience of description, it is assumed that the number of detailed bands constituting the IF band is three as shown in FIG. 3.

An amplifier 401 that is located at a first stage of the smart upconverter for broadband satellite communication amplifies overall signals of the input IF band 301, and a distributor 402 distributes the amplified signals to detailed band pass filters 403, 404, and 405 constituting a filter bank 406.

Each of the detailed band pass filters 403, 404, and 405 is designed to pass only one of the detailed bands 302, 303, and 304, and is connected to a first mixer 408 by a switch 407 of the next stage thereof.

After first upconverting is performed by the first mixer 408 and a local oscillator 409, unnecessary spurious components are removed by a filter 410. Further, Ifs are set for the filter 410 such that the filter 410 passes only the first detailed band 302.

A signal level measurer 411 of the next stage of the filter 410 measurers levels of signals input to the smart upconverter for broadband satellite communication, and this information is transmitted to a controller 419.

The controller 419 sequentially switches the detailed band pass filters 403, 404, and 405 of the filter bank 406 according to a designated algorithm, and simultaneously instructs the first local oscillator 409 to change its frequency.

The controller 419 compares the levels of the signals measured by the signal level measurer 411, and determines into which of the detailed bands the signals are input. When the detailed band used is determined through this process, the controller 419 stops the algorithm that finds the detailed band, and determines a frequency of a second local oscillator 415 on the basis of information about the found detailed band.

Then, the smart upconverter for broadband satellite communication is normally operated. When the detailed band to which input transmission channels belong is converted into the IFs through the first mixer 408 and the local oscillator 409, only a desired detailed band is passed through the filter 410, and the remaining detailed bands are removed.

Subsequently, the desired detailed band is amplified by an amplifier 412, passes through a filter 413, and is converted into a radio frequency (RF) band, which is finally transmitted to a satellite, by the second mixer 414 and the local oscillator 415. Further, the converted RF band is sufficiently amplified and output by a drive amplifier 417 and an output amplifier 418.

When broadband IF signals of 950 MHz to 1950 MHz are converted into RF signals at the satellite communication earth station, and when the transmission channels are in the first detailed band 302 of FIG. 3, a problematic 2IF signal (2×950 MHz=1900 MHz) is found in the third detailed band 304. In the smart upconverter for broadband satellite communication according to the present invention, the second detailed band 303 and the third detailed band 304 are removed by the filter 410. Thus, the smart upconverter can prevent a problem with the spurious components.

When the transmission channels are in the second detailed band 303 of FIG. 3, the problematic 2IF signal is found in the right of the third detailed band 304. As such, in the smart upconverter for broadband satellite communication according to the present invention, only the detailed band 303 passes through the filter 410, and the first detailed band 302 and the third detailed band 304 are removed by the filter 410. Thus, the smart upconverter can prevent the problem with the spurious components.

In addition, when the transmission channels are in the third detailed band 303 of FIG. 3, noises included in the channels (c1, c2, etc.) that are to the right of start frequencies of the IF band of 950 MHz act as the 2IF signal. As such, the noises acting as the 2IF signal are found on the transmission channels near the 1900 MHz band of the third detailed band 303. This causes a problem with the spurious components and degrades signal quality. However, in the smart upconverter for broadband satellite communication according to the present invention, only the third detailed band 304 passes through the filter 405, and the first detailed band 302 and the second detailed band 303 are removed by the filter 405. As such, the smart upconverter removes noises acting as the spurious components in advance, thereby preventing the problem with the spurious components.

FIG. 5 is a flowchart showing a process of determining a detailed band in the smart upconverter for broadband satellite communication according to the embodiment of the present invention. An algorithm used in the present invention to determine to which of the detailed bands 302, 303, and 304 of the input IF band 301 of the smart upconverter for broadband satellite communication signals belong may be given as in FIG. 5. Referring to FIGS. 3 to 5, first, when a power supply of the smart upconverter for broadband satellite communication such as a block upconverter (BUC) is turned on (S501), frequencies of the switch 407 and the first local oscillator 409 are set so that the first detailed band is upconverted.

The filter 410 is set to pass the IF band corresponding to the first detailed band at all times. As such, the signal level measurer 411 measurers the levels of input signals (S502), and transmits the measured values to the controller 419. The controller 419 stores these values as signal levels of the first detailed band 302 (S503).

After step S503, when the controller 419 determines a change of the detailed band (S504), the frequencies of the switch 407 and the local oscillator 409 are changed into those of the second detailed band 303 (S505 and S506), and then the process returns to step S502. Thus, the second detailed band 303 is converted into the IF band corresponding to the first detailed band 302 by the first mixer 408. Then, the signals of the second detailed band 303 pass through the filter 410, and are input to the signal level measurer 411. In addition, the levels of the input signals are measured (S502), and the controller 419 stores this values as signal levels of the second detailed band 303 (S503).

The signal levels that pass through all the detailed band pass filters constituting the filter bank 406 are measured through such processes, and these values are compared with each other. Then, the detailed band having the highest signal level is determined as the detailed band including the transmission signals (S507).

Next, the frequencies of the local oscillator 415 are adjusted by the controller 419, and the detailed band of the IF band including the transmission signals is restored to an original state of the RF band (S508). Also, controller 419 turns on the output amplifier 418, and controls the output amplifier 418 to perform power amplification on the desired transmission signals (S509).

Although the present invention has been described through a certain embodiment, it shall be appreciated that various permutations and modifications of the described embodiment are possible by those skilled in the art to which the present invention pertains without departing from the scope of the invention. Therefore, the scope of the present invention shall not be defined by the described embodiment but shall be defined by the appended claims and their equivalents.

### INDUSTRIAL APPLICABILITY

According to the smart upconverter for broadband satellite communication according to the embodiment of the present invention, the problem with specific spurious components generated during conversion of broadband IFs of 1 GHz for the purpose of application to a satellite earth station is solved to remove the influence of the spurious components on other channels. Thereby, the smart upconverter greatly contributes to improvement in signal quality of satellite communication.

1. A smart upconverter for broadband satellite communication, which automatically senses to which of detailed bands of an intermediate frequency (IF) broadband transmission signals belong at a broadband satellite communication earth station, pre-removes at least one of the detailed bands which generates spurious components (2IF+LO) that is not used in upconverting, and prevents a problem with the spurious components in an in-band including the transmission signals.

2. The converter as set forth in claim 1, further comprising a filter bank made up of detailed band pass filters, and a switch, both of which are provided to find the transmission channels in the IF broadband before first upconverting,
wherein, after the first upconverting is performed, unnecessary spurious components are removed by the filter, and levels of the signals are measured by a signal level measurer, and are input to a controller.

3. The converter as set forth in claim 2, wherein, when the detailed band to which the transmission signals belong is converted into IFs by a mixer provided after the switch and by a local oscillator provided between the controller and the mixer, the filter passes only one of the detailed bands constituting the IF broadband so as to pass through one detailed band including the transmission channels and remove the remaining detailed band.

4. The converter as set forth in claim 3, further comprising:
an amplifier provided at a first stage to amplify overall signals of the IF broadband; and
a distributor provided after the amplifier and distributing the detailed bands obtained by dividing the amplified signals of the IF broadband to the detailed band pass filters constituting the filter bank.

5. The converter as set forth in claim 4, wherein:
the signals passing through each of the detailed band pass filters constituting the filter bank pass through the switch, and are input to the mixer; and
the switch causes only one desired detailed band to be input by switching.

6. The converter as set forth in claim 5, wherein, after the levels of the signals of the detailed band including the transmission channels in the detailed band of the IF broadband are stored, the levels of the signals passing through all the detailed band pass filters constituting the filter bank are measured by the signal level measurer in a process of switching the detailed band pass filters constituting the filter bank, the measured values are compared with each other, and a band having the highest signal level is determined as the detailed band.
